(19) United States
(12) Patent Application Publication
(10) Pub. No.: US 2006/0250540 A1
(43) Pub. Date: Nov. 9, 2006

(54) Image display device

(76) Inventor: Stefan Wellhofer, Schlossvippach (DE)

Correspondence Address: JANSSON, SHUPE, MUNGER & ANTARAMIAN, LTD, 245 MAIN STREET, RACINE, WI, 53403, US

(21) Appl. No.: 11/417,745

(22) Filed: May 4, 2006

(30) Foreign Application Priority Data
May 4, 2005 (EP) 05 009 826.8

(51) Int. Cl. G02F 1/1333; G06F 1/16

(52) U.S. Cl. 349/58; 361/681

(57) ABSTRACT

The image display device (1) comprises a display unit (3), a frame (5) for framing a display unit (3) as well as a rear wall (9), wherein the display unit (3) and the rear wall (9) are connected with the frame (5), and wherein the frame (5) is formed of elongate profile rails (7) which are connected to one another on their front ends and which are held together by means of a tensioning belt (17) which is arranged at an outer surface of first legs (13) of the profile rails (7) to surround the frame, and wherein in the area of the apex of a profile rail (7) an angular outer shoulder (21) is provided which forms a recess into which the rear wall (9) is inserted.

### CROSS REFERENCE TO RELATED APPLICATION

This application claims the benefit under 35 U.S.C. §119 of European application EP 05 009 826.8, filed May 4, 2005.

### FIELD OF THE INVENTION

The present invention refers to an image display device having a display unit, a frame for framing the display unit, and a rear wall. The invention particularly refers to flat screens.

### BACKGROUND OF THE INVENTION

Image display devices of this kind have been known for a long time and are used for displaying all types of image formats, e.g. as LCD TV sets, plasma TV sets or respective monitors for computers. The manufacture of such image display devices is usually very laborious, since first of all the profile rails of the frame of the image display device must be welded, adhered or compressed together directly or via angle joints to provide a safe connection. Subsequently, the display unit itself must be connected to this frame in a safe manner. On the whole, the assembly is relatively labour-intensive and costly, and a disassembly of the image device in the case of required repair work is also time-consuming and expensive.

To simplify the assembly, a frame was suggested in EP 1 420 140 B1, which consists of profile rails, which are connected to one another on their front ends, wherein an angle joint is arranged between the front ends of two adjoining profile rails. The profile rails have a channel on their inner side with a clamping element extending in said channel so that the clamping element is accessible from the inner side of the frame, and said clamping element clamps the profile rails with one another from the inner side of the frame. Although this enables a simpler assembly of the frame compared to conventional methods, the increased amount of components is disadvantageous, and the insertion of the display unit can only be performed after assembly of the frame.

Thus, it is the object of the present invention to provide an image display device, which can be assembled and disassembled in a particularly easy manner and in which the manufacturing costs are significantly reduced.

### SUMMARY OF THE INVENTION

According to the invention the image display device comprises a display unit, a frame for framing the display unit, and a rear wall, wherein the display unit and the rear wall are connected to the frame, and the frame is formed of elongate profile rails, which are connected to one another on their front ends and which are held together by means of a tensioning belt, which is arranged at outer surfaces of the first legs of the profile rails to surround the frame.

Thus, it is possible to completely coat the individual profile rails before assembly, to enable a simple and cost-effective assembly of the image display device and to enable several arrangement alternatives of the display unit on the frame.

The profile rails are substantially formed angularly with a first and a second leg. This on the one hand increases stability of the profile rails, on the other hand the length of the second leg can be varied to adapt to the desired dimensions of the display unit.

An angular outer shoulder for forming a recess is provided in the area of the apex of a profile rail, wherein the rear wall is inserted into said recess. Thus, a connection between the rear wall and the frame is produced in an especially simple manner, wherein said connection does not need connection elements visible towards the outside.

The first leg preferably comprises a channel on its outer side in which the tensioning belt extends, whereby a safe guidance of the tensioning belt is ensured and a lateral displacement of same is prevented.

The front ends of the profile rails are preferably beveled at an angle of approximately 45° so that a 90° outer edge results between adjoining profile rails. This enables the direct assembly of the profile rails without interposed angle joints.

The tensioning belt preferably consists of plastics, preferably of PET, which on the one hand ensures a safe and durable clamping of the system components and which on the other hand ensures a simple exchange.

According to the present invention, the display unit may also be fixed and held by means of the force of the tensioning belt of at least two first legs of the profile rails. Thus, the attachment of the display unit on the frame becomes an integral step of the frame assembly procedure, and further assembly is not required.

Supporting rails are advantageously attached at the display unit, which are in engagement with a channel on the inner side of the first leg of the profile rails, which ensures a safe alignment of the display unit with respect to the profile rails.

The supporting rails preferably comprise outwardly directed spring tongues, which are fixed in the channel on the inner side of the first leg of the profile rails so that a durable connection between the display unit and the profile rails is achieved in a simple manner.

It is advantageous that in the area of the apex of a profile rail a groove is provided on the inner side in which an alignment frame is inserted. This feature is especially advantageous for the assembly of the image display device, since the profile rails are first of all plugged onto the alignment frame and can be aligned before the tensioning belt is tightened without a later removal of the alignment frame becoming necessary. This alignment frame may also project over the second leg of the profile rails as a type of passepartout and may have any color.

### SHORT DESCRIPTION OF THE DRAWINGS

Further details, features and advantages of the present invention can be derived from the following description with reference to the drawings.

FIG. 1 is a front view of an image display device according to the invention;

FIG. 2 is a schematic perspective view, partially shown in cross-section, of an image display device according to the invention;

FIG. 3 is a cross-sectional view along line C-C of FIG. 1;

FIG. 4 is a perspective view of only the frame of an image display device according to the invention;

FIG. 5 is an enlarged view of the section of FIG. 4 indicated at B;

FIG. 6 is a perspective view, partially shown in cross-section, of a profile rail and a rear wall of an image display device according to the invention;

FIG. 7 is an enlarged view of the section of FIG. 2 indicated at E;

FIG. 8 is an enlarged cross-sectional view of the section of FIG. 2 indicated at D; and

FIG. 9 is a view of a supporting rail of the display unit according to an embodiment of the invention.

### DETAILED DESCRIPTION OF PREFERRED EMBODIMENTS

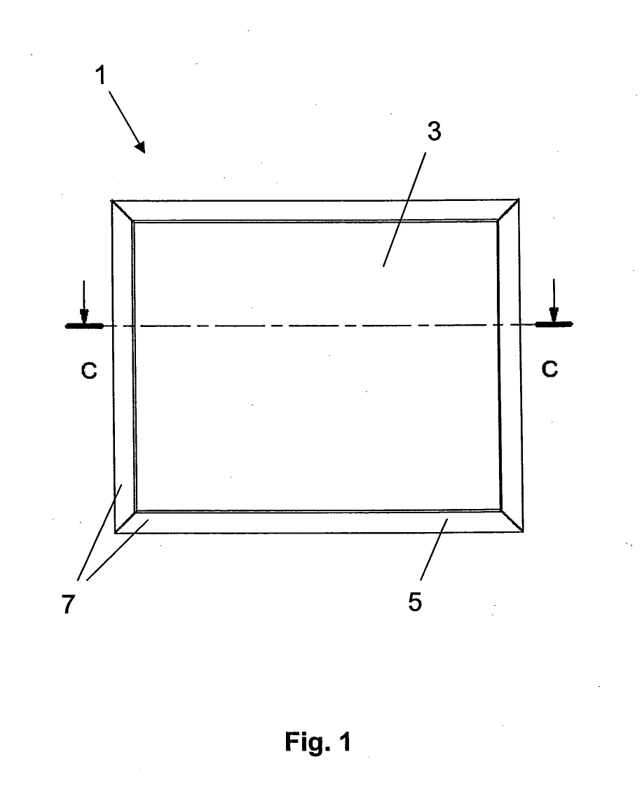

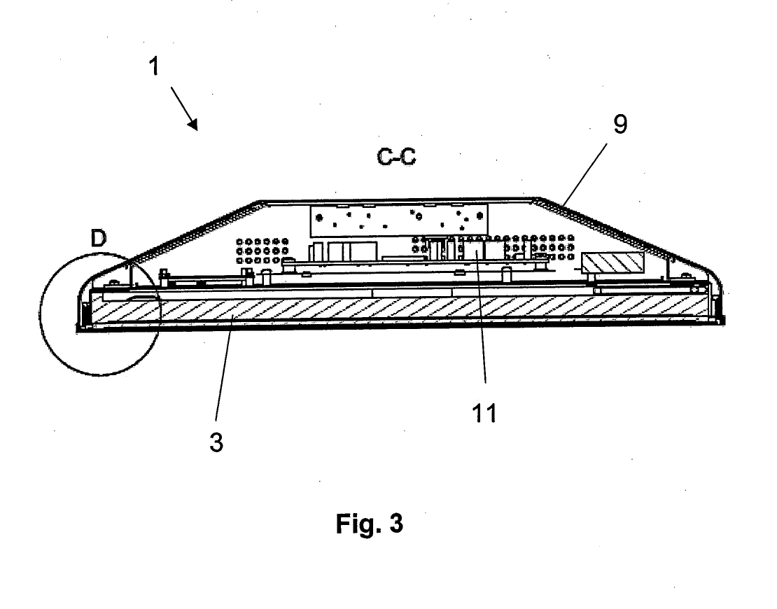

FIGS. 1 to 9 show a preferred embodiment of the invention in detail.

FIG. 1 shows an image display device 1 according to the invention in a front view. The image display device 1 consists of a display unit 3, which is usually formed as a LCD panel or a plasma panel with a protective cover plate. The transparent protective plate is usually adhered onto the panel. The image display device 1 further comprises a frame 5, which serves for framing the display unit 3 and which in the present example is composed of four elongate straight profile rails 7. These profile rails 7 consist e.g. of aluminum and are beveled on their front ends at an angle of approx. 45° so that a 90° outer edge results between adjoining profile rails 8. However, constructions are also conceivable in which a rounding exists instead of the edge in the transitional area between two profile rails 7. The use of angle joints is also conceivable. The frame 5 shall also be tight against electromagnetic radiation.

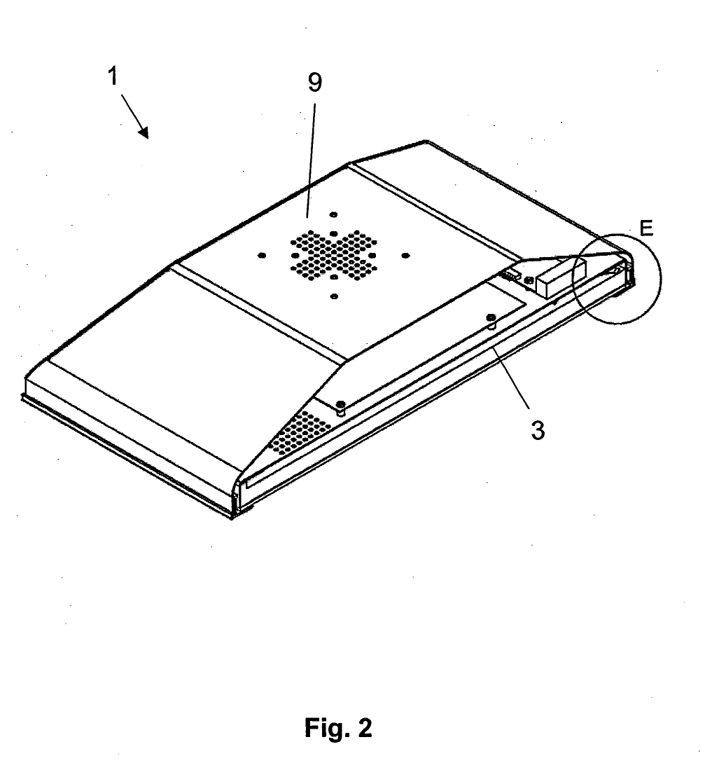

As may be seen from FIG. 2, the image display device 1 also comprises a rear wall 9, which is connected to the frame 5. This rear wall 9 may be formed integrally or it may be composed of several members, and it is connected to the frame 5 on all four sides.

As may be seen from the cross-sectional view according to line C-C of FIG. 1, the required electrical/electronic units 11 for operation of the image display device are arranged in the space formed between the display unit 3 and the rear wall 9.

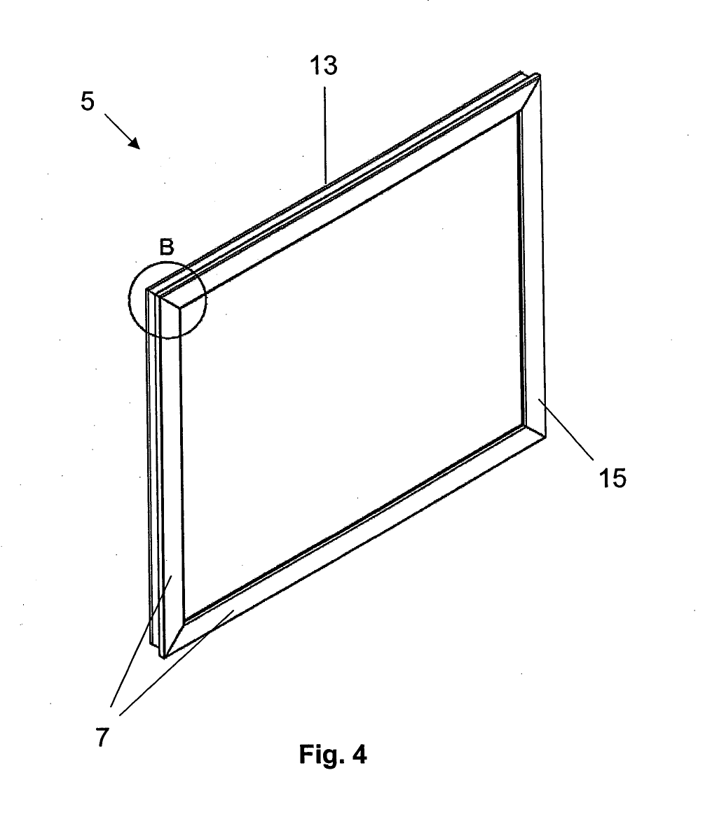

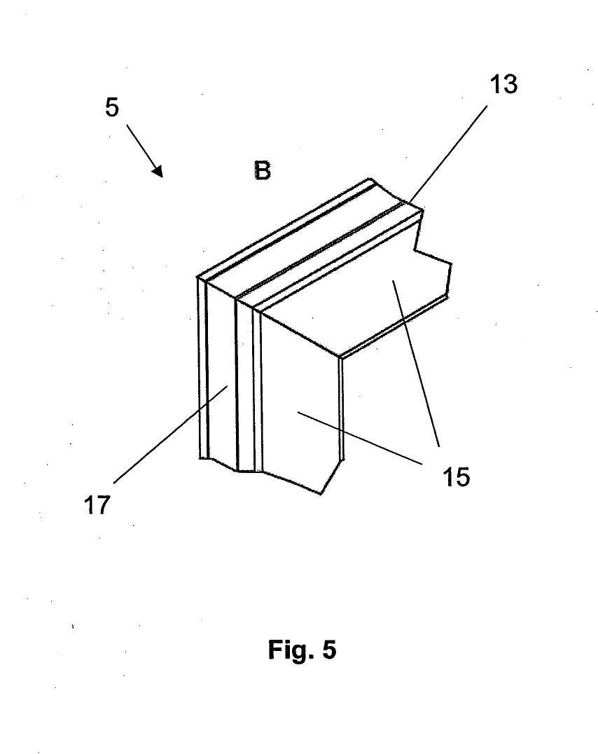

FIG. 4 and the enlarged view of the area B in FIG. 5 show the outer structure of the frame 5 of an image display device 1 according to the invention. The profile rails 7 are formed angularly and comprise a first leg 13 and a second leg 15 extending substantially rectangularly to the first leg defining an apex in-between the first and second legs. While the second leg 15 serves for defining the visible portion of the display unit 3 as well as for reinforcement, a tensioning belt 17 is arranged and tightened on an outer surface of the first leg 13 of each profile rail 7 so as to surround the frame 5. The individual profile rails 7 are thereby joined in a precisely tailored manner and are durably secured against mutual displacement. The tensioning belt 17 should to a certain extent have elastic properties, but still have special tensile strength and be tearproof and stable since in the case of long-term use a safe connection of the profile rails 7 has to be ensured without the risk of the tensioning belt 17 wearing out. For this purpose several plastic materials are particularly suitable, for example a tensioning belt 17 of PET (polyethyleneterephthalate). In the present example a belt with a width of approx. 12 mm and a thickness of approx. 0.75 mm was used.

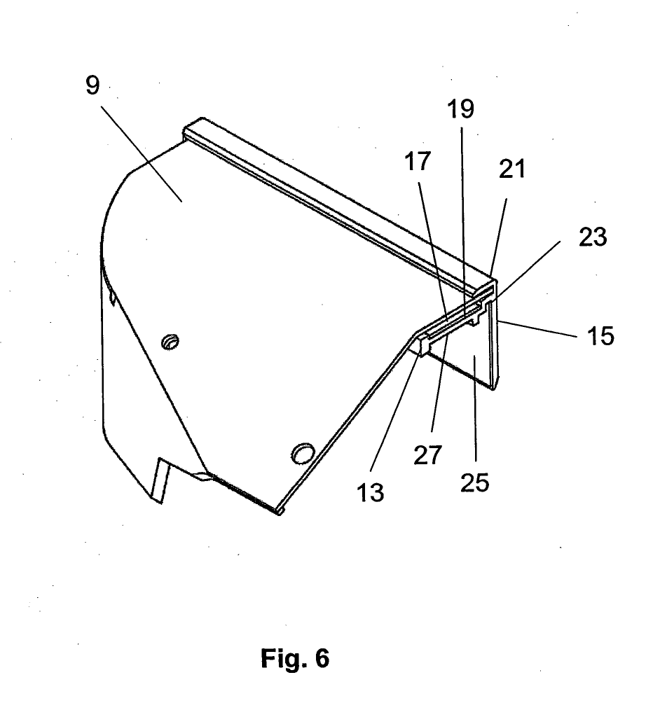

As becomes even clearer from the view of FIG. 6, a channel 19 is formed on the outer side of the first leg 13, with a tensioning belt 17 being circumferentially formed in said channel. By means of this channel a lateral movement of the tensioning belt 17 in the assembled state is additionally prevented. In the area of the apex of the angular profile rails 7, an angular outer shoulder 21 is additionally formed so that a U-shaped recess results, which is open towards the back and which serves for accommodating the rear wall 9. Moreover, a groove 23 extending in parallel to the second leg 15 is arranged in the area of the apex of the profile rails 7 on the inner side, said groove serving for being plugged onto an alignment frame 25. This alignment frame 25 is usually made of a thin sheet and first of all serves for aligning the profile rails 7 prior to the tensioning process. However, when using alignment frames 25, which project inwardly over the second leg 15, aesthetic aspects can additionally be realized because of the passepartout effect generated. This alignment frame 25 may also be dyed in any color. On the inner side of the first leg 13 of each profile rail 7 a channel 27 is also formed which serves for fixing and supporting the display unit 5.

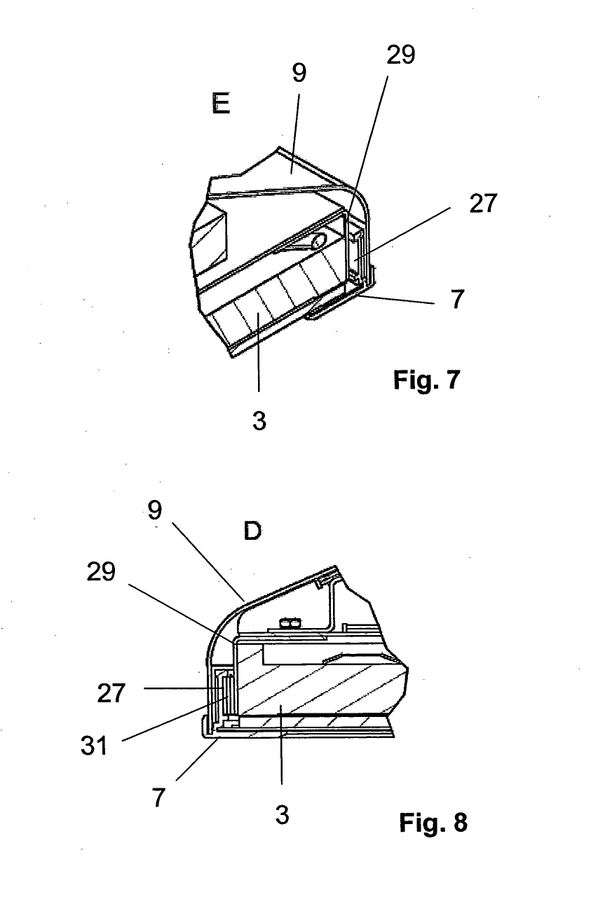

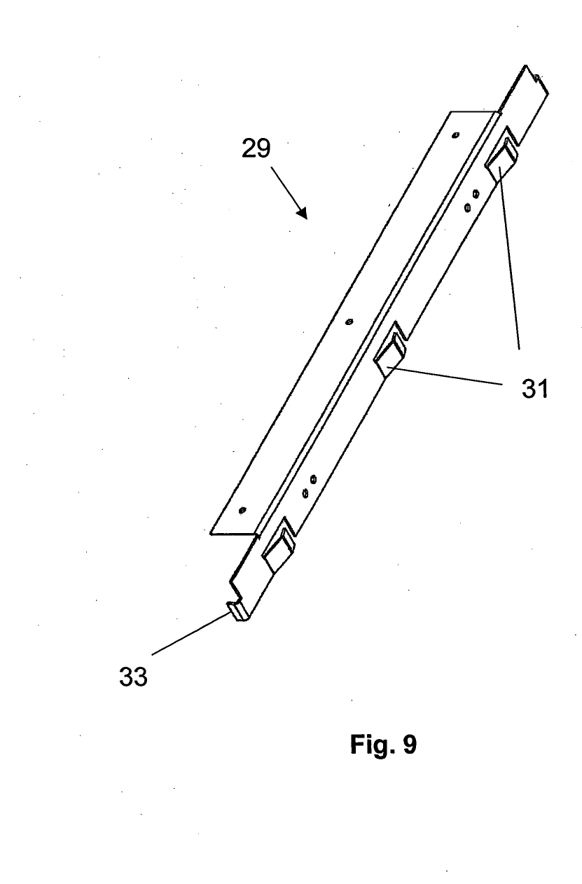

As becomes clear from the enlarged view of FIG. 7 and 8, the display unit 3 is connected to a supporting rail 29, usually via screw connections. The holding rails, an example of which being shown in FIG. 9, serve for engagement with the profile rails 7 of the frame 5. To obtain an especially simple connection, outwardly projecting spring tongues 31 are formed on the legs of the angular supporting rails 29, said spring tongues fitting into the channel on the inner side of the first leg 13 of the profile rails 7. Caused by this arrangement, a fixing of the display unit 3 on the frame 5 is achieved preventing a forward and backward movement as well as a movement towards the right and left sides. Such supporting rails 29 may be arranged on all four sides of the display unit 3, however, it is also sufficient to attach such supporting rails 29 only on two opposing sides, if additionally a fixing in the upward and downward direction is provided, for instance by noses 33 formed on the longitudinal ends of the supporting rails 29.

In such an embodiment the assembly is carried out especially simple in the following manner. First of all the supporting rails 29 are attached on at least two opposing sides of the display unit 3. Subsequently, the profile rails 7 are plugged from the outside onto the alignment frame 25, wherein at the same time the spring tongues 31 of the supporting rails 29 are accommodated in the channel 19. A tensioning belt 17 is arranged in the channel 19 circumferentially around the outer surfaces of the first legs 13 of the profile rails 7, is fastened by a device known per se and is assembled to form a closed belt. Subsequently, only the rear wall 9 must be inserted into the recesses provided for this purpose and must be attached with any connection elements on the supporting rails 29 or the display unit 3.

Since the tensioning belt 17 lies on the outer circumference of the frame, conventional attachment methods of the the display unit 3 to the frame after completion of the assembly of the frame 5 are also conceivable, e.g. by means of screwing. It is also conceivable to provide only an external provisional alignment device, which can be removed after assembly of the frame 5, instead of the integrated alignment frame.

Thus, an image display device is created by the present invention, which can be assembled and also disassembled in a particularly simple and flexible manner, which is also cost-effective and which enables a safe and durable fixing of the components.

1. Image display device comprising a display unit, a frame for framing the display unit, and a rear wall, wherein the display unit and the rear wall are connected to the frame, and wherein the frame is formed of elongate profile rails, which are joined on front end sides thereof and which are held together by means of a tensioning belt, wherein the profile rails are formed substantially angularly having a first and a second leg defining an apex in-between, wherein the tensioning belt is arranged at outer surfaces of the first legs of the profile rails to surround the frame, and wherein in the area of the apex of a profile rail an angular outer shoulder is provided which forms a recess into which the rear wall is inserted.

2. Image display device as claimed in claim 1, wherein the first leg has a channel on its outer side with the tensioning belt extending in said channel.

3. Image display device as claimed in claim 1, wherein the front ends of the profile rails are beveled at an angle of approx. 45° so that a 90° outer edge between adjoining profile rails results.

4. Image display device as claimed in claim 1, wherein the tensioning belt is formed of plastics.

5. Image display device as claimed in claim 1, wherein the display unit is fixed and held by means of the force of the tensioning belt of at least two legs of the profile rails.

6. Image display device as claimed in claim 1, wherein a groove is internally formed in the area of the apex of a profile rail with an alignment frame being inserted in said groove.

7. Image display device as claimed in claim 1, wherein supporting rails are attached at the display unit which are in engagement with a channel on an inner side of the first leg of the profile rails.

8. Image display device as claimed in claim 7, wherein the supporting rails comprise outwardly directed spring tongues which are defined in the channel on the inner side of the first leg of the profile rails.
